(19) United States
(12) Patent Application Publication
(10) Pub. No.: US 2014/0172278 A1
(43) Pub. Date: Jun. 19, 2014

(54) INTERNAL EGR AMOUNT CALCULATION DEVICE FOR INTERNAL COMBUSTION ENGINE

(71) Applicant: HONDA MOTOR CO., LTD., Tokyo (JP)

(72) Inventor: Yosuke KOSAKA, Wako-shi (JP)

(73) Assignee: HONDA MOTOR CO., LTD., Tokyo (JP)

(21) Appl. No.: 14/068,210

(22) Filed: Oct. 31, 2013

(30) Foreign Application Priority Data
Dec. 18, 2012 (JP) 2012-275304

(51) Int. Cl. F02D 41/00

(52) U.S. Cl. CPC F02D 41/0072
USPC 701/108

(57) ABSTRACT

An internal EGR amount calculation device for an internal combustion engine, which is capable of improving calculation accuracy of an internal EGR amount in a case where a valve overlap time period is changed. The internal EGR amount calculation device for an internal combustion engine of which the internal EGR amount is changed according to the valve overlap time period calculates an in-cylinder volume at a blow-back occurrence timing, which is a timing in which blow-back of exhaust gases from an exhaust passage into a cylinder occurs after the intake valve is opened, during the valve overlap time period, according to engine speed and an intake cam phase, calculates a remaining gas amount according to the in-cylinder volume, and calculates the internal EGR amount by adding a blown-back gas amount to the remaining gas amount.

### BACKGROUND OF THE INVENTION

1. Field of the Invention

The present invention relates to an internal EGR amount calculation device for an internal combustion engine, for calculating an internal EGR amount of the engine.

2. Description of the Related Art

Conventionally, an internal EGR amount calculation device for an internal combustion engine is known as disclosed in Japanese Laid-Open Patent Publication (Kokai) No. 2004-251182. In this internal EGR amount calculation device, an internal EGR amount is calculated by adding the amount of blown-back gases to the amount of remaining burned gases. The amount of remaining burned gases represents the amount of burned gases remaining in a cylinder, and it is regarded, in Japanese Laid-Open Patent Publication (Kokai) No. 2004-251182, to be equal to the amount of burned gases remaining in the cylinder immediately before opening an associated intake valve. This is based on technical points of view that part of burned gases remaining in the cylinder immediately before opening the intake valve continues to remain in the cylinder, and the other part of the burned gases temporarily flow out of the cylinder into an intake passage during a valve overlap time period, and then flow back into the cylinder again before termination of the intake stroke. Further, the amount of remaining burned gases is calculated specifically by calculating an in-cylinder volume of gases in the cylinder immediately before opening the intake valve, based on the valve-opening timing of the intake valve, the bore diameter of the cylinder, and piston stroke and clearance volume, and applying the calculated in-cylinder volume to the equation of state of gas.

Further, the amount of blown-back gases represents the amount of burned gases blown back into the cylinder after the burned gases temporarily flow from an exhaust passage into the intake passage due to a pressure difference between the intake passage and the exhaust passage, during the valve overlap time period. The amount of blown-back gases is calculated by regarding a path through which burned gases flow as a nozzle and using a nozzle equation. The nozzle equation includes an integral value of an effective opening area. The integral value of the effective opening area is calculated as a function of the length of the valve overlap time period (i.e. crank angle from the valve-opening timing of the exhaust valve to the valve-closing timing of the intake valve) and the rotational speed of the engine.

In the case of Japanese Laid-Open Patent Publication (Kokai) No. 2004-251182, the amount of burned gases remaining in the cylinder immediately before opening the intake valve is regarded to be equal to the amount of burned gases remaining in the cylinder after termination of the intake stroke based on the above-described technical points of view. However, after the intake valve is opened, due to a pressure difference between the cylinder and the exhaust passage and an increase in pressure within the cylinder caused by the rise of the piston during the exhaust stroke, part of the burned gases remaining in the cylinder immediately before opening the intake valve flows out into the exhaust passage to be directly discharged via the exhaust passage without returning to the cylinder. As a consequence, an actual amount of remaining burned gases becomes smaller in value than the amount of burned gases remaining in the cylinder immediately before opening the intake valve, and therefore the calculation method disclosed in Japanese Laid-Open Patent Publication (Kokai) No. 2004-251182 produces an error in which a calculated value of the amount of remaining burned gases becomes much larger than an actual value thereof. This causes the internal EGR amount to be calculated as a value much larger than the actual value, resulting in the degraded calculation accuracy of the internal EGR amount. Particularly, in a case where the valve overlap time period is changed by a variable valve mechanism, as disclosed in Japanese Laid-Open Patent Publication (Kokai) No. 2004-251182, the above-mentioned problem can become more conspicuous.

### SUMMARY OF THE INVENTION

It is an object of the present invention to provide an internal EGR amount calculation device for an internal combustion engine, which is capable of improving calculation accuracy of an internal EGR amount when a valve overlap time period is changed.

To attain the above object, the present invention provides an internal EGR amount calculation device for an internal combustion engine in which a valve overlap time period is changed by changing valve timing of at least one of an intake valve and an exhaust valve, and an internal EGR amount, which is an amount of gases remaining in a cylinder, is changed according to the change in the valve overlap time period, comprising in-cylinder volume-calculating means for calculating an in-cylinder volume at a blow-back occurrence timing, which is a timing at which blow-back of exhaust gases from an exhaust passage into the cylinder occurs after the intake valve is opened, during the valve overlap time period, and internal EGR amount-calculating means for calculating the internal EGR amount according to the calculated in-cylinder volume.

With the configuration of this internal EGR amount calculation device, the internal EGR amount is calculated according to the calculated in-cylinder volume. This in-cylinder volume is calculated as a value obtained at the blow-back occurrence timing, which is the timing in which the blow-back of exhaust gases from the exhaust passage into the cylinder occurs after the intake valve is opened, during the valve overlap time period, and hence differently from the method disclosed in Japanese Laid-Open Patent Publication (Kokai) No. 2004-251182, it is possible to calculate the internal EGR amount as a value exclusive of the amount of burned gases which flows out into the exhaust passage before occurrence of the blow-back of exhaust gases after the intake valve is opened. This makes it possible to make the internal EGR amount closer to an actual value than by the method disclosed in Japanese Laid-Open Patent Publication (Kokai) No. 2004-251182, whereby it is possible to improve the calculation accuracy of the internal EGR amount.

Preferably, the internal EGR amount-calculating means includes remaining gas amount-calculating mean for calculating a remaining gas amount of gases remaining in the cylinder according to the in-cylinder volume, and calculates the internal EGR amount using the calculated remaining gas amount.

With the configuration of the preferred embodiment, since the remaining gas amount of gases remaining in the cylinder is calculated according to the in-cylinder volume, the remaining gas amount can be accurately calculated as a value exclusive of the amount of burned gases flowing out into the exhaust passage before occurrence of the blow-back of exhaust gases after the intake valve is opened. Further, since the internal EGR amount is calculated using the remaining gas amount accurately calculated as above, it is possible to further improve the calculation accuracy of the internal EGR amount.

More preferably, the internal EGR amount calculation device further comprises minimum exhaust pressure-obtaining means for obtaining a minimum exhaust pressure, which is a minimum value of pressure within the exhaust passage during the valve overlap time period, and the internal EGR amount-calculating means further includes blown-back gas amount-calculating mean for calculating a blown-back gas amount, which is an amount of gases which temporarily flow out of the cylinder into at least one of an intake passage and the exhaust passage, and then flow back into the cylinder again, according to the obtained minimum exhaust pressure, and calculates the internal EGR amount further using the calculated blown-back gas amount in addition to the remaining gas amount.

With the configuration of the preferred embodiment, the minimum exhaust pressure, which is the minimum value of the pressure within the exhaust passage during the valve overlap time period, is obtained, and the blown-back gas amount, which is the amount of gases which temporarily flow out of the cylinder into at least one of the intake passage and the exhaust passage, and then flow back into the cylinder again, is calculated according to the obtained minimum exhaust pressure. In this case, the present assignee has confirmed by experiment that in the engine capable of changing the valve overlap time period, when the blown-back gas amount is calculated, when the valve overlap time period is long or when the operating load of the engine is high, the calculation accuracy of the blown-back gas amount is enhanced by using the minimum value of the pressure within the exhaust passage during the valve overlap time period (see e.g. FIGS. 9 and 10 of Japanese Patent Application No. 2012-152089). Therefore, under such conditions, the calculation accuracy of the blown-back gas amount can be improved. Furthermore, the internal EGR amount is calculated further using the blown-back gas amount accurately calculated as above in addition to the remaining gas amount, so that even when the valve overlap time period is long or even when the operating load of the engine is high, it is possible to accurately calculate the internal EGR amount, thereby making it possible to further improve the calculation accuracy of the internal EGR amount (Note that throughout the specification, the term “obtain” used in the phrases “obtaining a minimum exhaust pressure” and the like is intended to include the meaning of directly detecting parameters, such as the minimum exhaust pressure, using sensors or the like, and calculating the parameters).

Preferably, the engine includes a variable intake cam phase mechanism for changing an intake cam phase, which is a phase of an intake camshaft for opening and closing the intake valve, with respect to a crankshaft, the internal EGR amount calculation device further comprising intake cam phase parameter-obtaining means for obtaining an intake cam phase parameter indicative of the intake cam phase, and the in-cylinder volume-calculating means calculates the in-cylinder volume according to the obtained intake cam phase parameter.

In general, in a case where the engine includes a variable intake cam phase mechanism for changing an intake cam phase, if the intake cam phase is changed by the variable intake cam phase mechanism, the valve-opening timing of the intake valve and the valve overlap time period are changed, and accordingly the blow-back occurrence timing as well is changed. In view of this, with the configuration of the preferred embodiment, the intake cam phase parameter indicative of the intake cam phase is obtained, and the in-cylinder volume is calculated according to the obtained intake cam phase parameter, so that it is possible to accurately calculate the in-cylinder volume while causing the change in the blow-back occurrence timing caused by a change in the intake cam phase to be reflected on the in-cylinder volume. This makes it possible to improve the calculation accuracy of the internal EGR amount even when the engine includes the variable intake cam phase mechanism.

Preferably, the internal EGR amount calculation device further comprises engine speed-obtaining means for obtaining an engine speed, which is a rotational speed of the engine, and the in-cylinder volume-calculating means calculates the in-cylinder volume according to the obtained engine speed.

With the configuration of the preferred embodiment, the engine speed, which is the rotational speed of the engine, is obtained, and the in-cylinder volume is calculated according to the obtained engine speed. In this case, as described hereinafter, the in-cylinder volume is highly correlated with the engine speed, and when the engine speed is changed, the in-cylinder volume is changed by the change in the engine speed. Therefore, by calculating the in-cylinder volume according to such an engine speed, it is possible to further improve the calculation accuracy of the internal EGR amount.

The above and other objects, features, and advantages of the present invention will become more apparent from the following detailed description taken in conjunction with the accompanying drawings.

### BRIEF DESCRIPTION OF THE DRAWINGS

FIG. 1 is a schematic diagram of an internal EGR amount calculation device according to an embodiment of the present invention and an internal combustion engine to which the internal EGR amount calculation device is applied;

FIG. 2 is a diagram of valve lift curves showing changes in valve timings of an intake valve and an exhaust valve caused by a variable intake cam phase mechanism and a variable exhaust cam phase mechanism;

FIG. 3 is a functional block diagram of the internal EGR amount calculation device;

FIG. 4 is a block diagram of a blown-back gas amount-calculating section;

FIG. 5 is a diagram showing an example of a map for use in calculating a function value CdA;

FIG. 6 is a diagram showing results of measurement of an exhaust flow rate and an intake flow rate under the conditions of NE=NE1, CAEX=0, and CAIN=0;

FIG. 7 is a diagram showing results of measurement of the exhaust flow rate and the intake flow rate under the conditions of NE=NE1, CAEX=0, and CAIN=CAIN_ref;

FIG. 8 is a diagram showing the relationship between an intake cam phase CAIN and an in-cylinder volume Vcylivc;

FIG. 9 is a diagram showing results of measurement of the exhaust flow rate and the intake flow rate under the conditions of CAIN=CAEX=CA_ref, and NE=NE1;

FIG. 10 is a diagram showing results of measurement of the exhaust flow rate and the intake flow rate under the conditions of CAIN=CAEX=CA_ref, and NE=NE2.

FIG. 11 is a diagram showing the relationship between engine speed NE and the in-cylinder volume Vcylivc; and

FIG. 12 is a diagram showing calculation errors in calculation of an internal EGR amount Gegr_int by a calculation method according to the present invention and a calculation method of a comparative example.

### DETAILED DESCRIPTION OF PREFERRED EMBODIMENTS

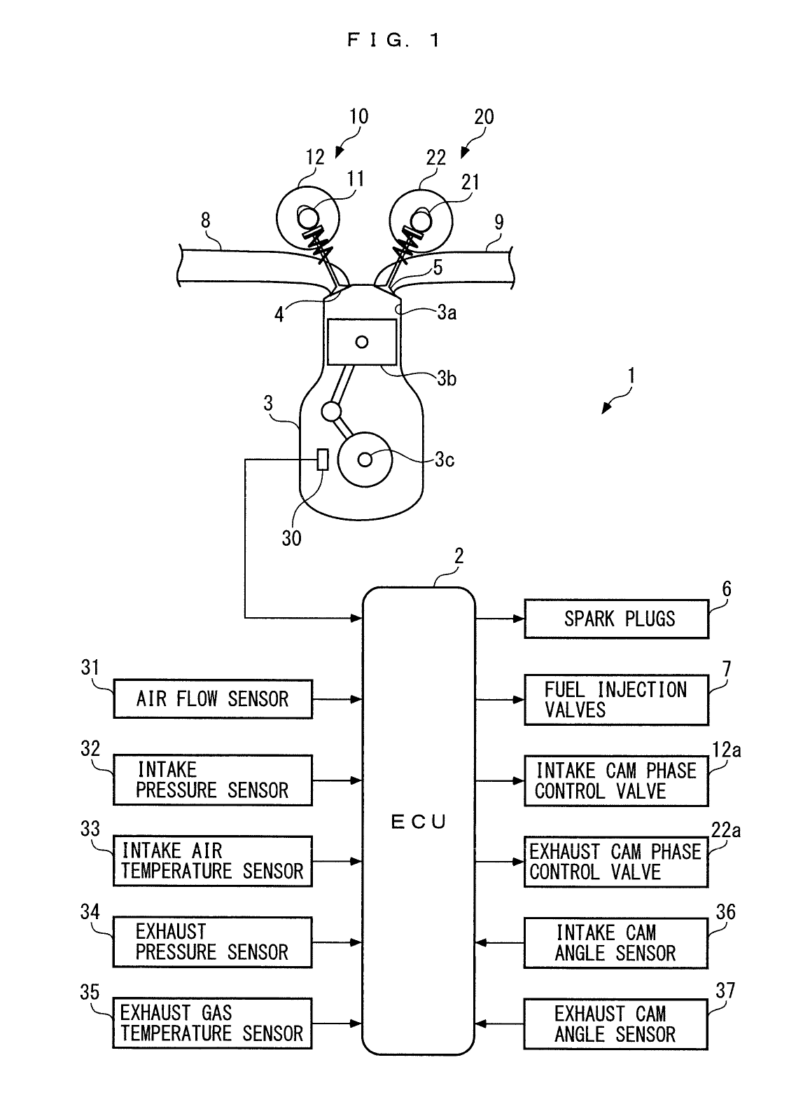

Hereafter, an internal EGR amount calculation device for an internal combustion engine according to an embodiment of the invention will be described with reference to drawings. As shown in FIG. 1, the internal EGR amount calculation device 1 includes an ECU 2. The ECU 2 calculates an internal EGR amount by a method, described hereinafter, and controls operating conditions of the internal combustion engine (hereafter referred to as the “engine”) 3 and so forth.

The engine 3 is an in-line four-cylinder gasoline engine having four pairs of cylinders 3a and pistons 3b (only one pair of which is shown), and is installed on a vehicle, not shown. The engine 3 includes intake valves 4 (only one of which is shown) provided for the respective cylinders 3a, exhaust valves 5 (only one of which is shown) provided for the respective cylinders 3a, an intake valve-actuating mechanism 10 for actuating the intake valves 4 to open and close the same, an exhaust valve-actuating mechanism 20 for actuating the exhaust valves 5 to open and close the same, and so forth.

The intake valve-actuating mechanism 10 comprises an intake camshaft 11 for actuating the intake valves 4, and a variable intake cam phase mechanism 12. The variable intake cam phase mechanism 12 steplessly (i.e. continuously) changes a phase CAIN of the intake camshaft 11 relative to a crankshaft 3c (hereafter referred to as the “intake cam phase CAIN”) to an advanced side or a retarded side, to thereby change the valve timing of each intake valve 4. The variable intake cam phase mechanism 12 is disposed at an end of the intake camshaft 11 toward an intake sprocket (not shown).

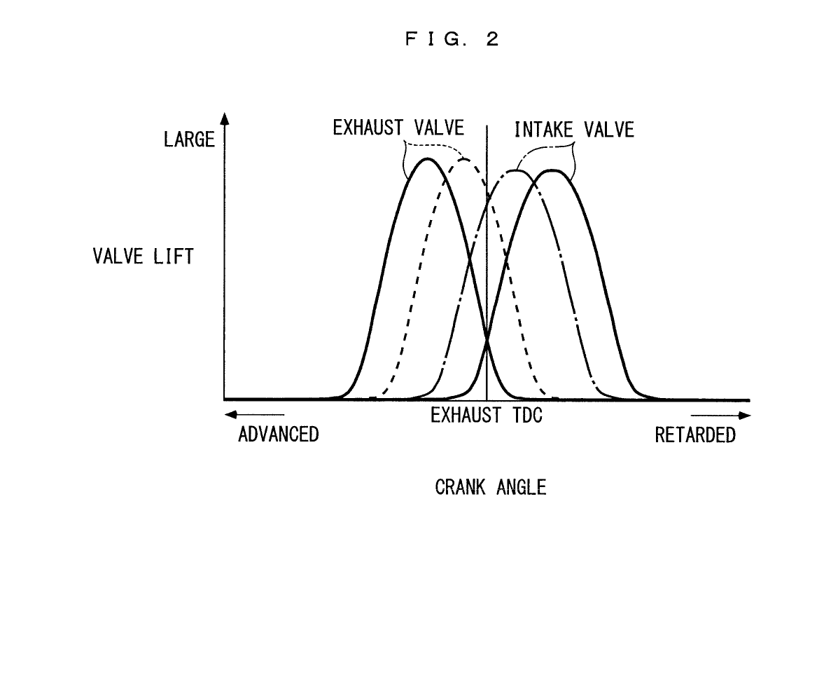

Although the variable intake cam phase mechanism 12 is configured, specifically, similarly to one proposed by the present assignee in Japanese Laid-Open Patent Publication (Kokai) No. 2007-100522, and hence detailed description thereof is omitted, the variable intake cam phase mechanism 12 includes an intake cam phase control valve 12a, etc. In the case of the variable intake cam phase mechanism 12, the intake cam phase control valve 12a is controlled by a drive signal from the ECU 2, whereby the intake cam phase CAIN is continuously varied between 0 and a predetermined most advanced value CAIN_ad. This steplessly changes the valve timing of each intake valve 4 between an origin timing indicated by a solid line in FIG. 2 and the most advanced timing indicated by a one-dot chain line in FIG. 2. Note that in FIG. 2, an exhaust top dead center is denoted as “EXHAUST TDC”. This also applies to figures, referred to hereinafter.

In this case, the predetermined most advanced value CAIN_ad is set to a predetermined positive value. Therefore, as the intake cam phase CAIN is increased from 0, the valve timing of each intake valve 4 is changed to a more advanced timing than the origin timing, whereby a valve overlap time period of each intake valve 4 and each exhaust valve 5 becomes longer.

The exhaust valve-actuating mechanism 20 comprises an exhaust camshaft 21 for actuating the exhaust valves 5, and a variable exhaust cam phase mechanism 22. The variable exhaust cam phase mechanism 22 steplessly (i.e. continuously) changes a phase CAEX of the exhaust camshaft 21 relative to the crankshaft 3c (hereafter referred to as the “exhaust cam phase CAEX”) to the advanced side or the retarded side, to thereby change the valve timing of each exhaust valve 5. The variable exhaust cam phase mechanism 22 is disposed at an end of the exhaust camshaft 21 toward an exhaust sprocket (not shown).

The variable exhaust cam phase mechanism 22 is configured similarly to the above-described variable intake cam phase mechanism 12, and includes an exhaust cam phase control valve 22a, etc. In the case of the variable exhaust cam phase mechanism 22, the exhaust cam phase control valve 22a is controlled by a drive signal from the ECU 2, whereby the exhaust cam phase CAEX is continuously varied between 0 and a predetermined most retarded value CAEX_rt. This steplessly changes the valve timing of each exhaust valve 5 between an origin timing indicated by a solid line in FIG. 2 and the most retarded timing indicated by a broken line in FIG. 2.

In this case, the predetermined most retarded value CAEX_rt is set to a predetermined positive value. Therefore, as the exhaust cam phase CAEX is increased from 0, the valve timing of each exhaust valve 5 is changed to a more retarded timing than the origin timing, whereby the valve overlap time period becomes longer.

Note that when there is such a valve overlap time period as described above, there occurs, as described hereinafter, a phenomenon in which burned gases temporarily flow out of the cylinder 3a into an exhaust passage 9 and thereafter flow into the cylinder 3a again, or a phenomenon in which burned gases temporarily flow through the cylinder 3a into an intake passage 8 and thereafter flow into the cylinder 3a again. In the following description, such burned gases that temporarily flow out of the cylinder 3a into the exhaust passage 9 and thereafter finally flow back into the cylinder 3a before the termination of the valve overlap time period, as described above, will be referred to as “blown-back gases”, and the amount of the blown-back gases will be referred to as the “blown-back gas amount”.

Further, the engine 3 is provided with spark plugs 6, fuel injection valves 7, and a crank angle sensor 30. The spark plugs 6 and the fuel injection valves 7 are provided for the respective cylinders 3a (only one of each of which is shown). The fuel injection valves 7 are mounted in an intake manifold such that fuel is injected into intake ports of the respective cylinders 3a. Both the spark plugs 6 and the fuel injection valves 7 are electrically connected to the ECU 2, and a fuel injection amount and fuel injection timing of fuel injected from each fuel injection valve 7, and an ignition timing at which a mixture is ignited by each spark plug 6 are controlled by the ECU 2. That is, fuel injection control and ignition timing control are executed by the ECU 2.

The crank angle sensor 30 delivers a CRK signal and a TDC signal, which are both pulse signals, to the ECU 2 along with rotation of the crankshaft 3c. Each pulse of the CRK signal is generated whenever the crankshaft 3c rotates through a predetermined crank angle (e.g. 1°). The ECU 2 calculates a rotational speed NE of the engine 3 (hereafter referred to as “the engine speed NE”) based on the CRK signal. Further, the TDC signal indicates that the piston 3b in each of the cylinders 3a is in a predetermined crank angle position slightly before the TDC position of the intake stroke, and each pulse thereof is delivered whenever the crankshaft rotates through 180°, in the case of the four-cylinder engine 3 of the present embodiment. Note that in the present embodiment, the crank angle sensor 30 corresponds to intake cam phase parameter-obtaining means and engine speed-obtaining means.

On the other hand, an air flow sensor 31, an intake pressure sensor 32, an intake air temperature sensor 33, an exhaust pressure sensor 34, an exhaust gas temperature sensor 35, an intake cam angle sensor 36, and an exhaust cam angle sensor 37 are electrically connected to the ECU 2. The air flow sensor 31 detects the flow rate of fresh air flowing through the intake passage 8, and delivers a signal indicative of the detected flow rate of fresh air to the ECU 2. The ECU 2 calculates an intake air amount GAIR based on the detection signal from the air flow sensor 31.

The intake pressure sensor 32 detects a pressure Pin within the intake passage 8 (hereafter referred to as the “intake pressure Pin”), and delivers a signal indicative of the detected intake pressure Pin to the ECU 2. The intake pressure Pin is detected as an absolute pressure. Further, the intake air temperature sensor 33 detects a temperature Tin of air within the intake passage 8 (hereafter referred to as the “intake air temperature Tin”), and delivers a signal indicative of the detected intake air temperature Tin to the ECU 2. The intake air temperature Tin is detected as an absolute temperature.

On the other hand, the exhaust pressure sensor 34 detects a pressure Pex within the exhaust passage 9 (hereafter referred to as the “exhaust pressure Pex”), and delivers a signal indicative of the detected exhaust pressure Pex to the ECU 2. The exhaust pressure Pex is detected as an absolute pressure. Note that in the present embodiment, the exhaust pressure sensor 34 corresponds to minimum exhaust pressure-obtaining means. Further, the exhaust gas temperature sensor 35 detects a temperature Tex of exhaust gases flowing through the exhaust passage 9 (hereafter referred to as the “exhaust gas temperature Tex”), and delivers a signal indicative of the detected exhaust gas temperature Tex to the ECU 2. The exhaust gas temperature Tex is detected as an absolute temperature.

Further, the intake cam angle sensor 36 is disposed at an end of the intake camshaft 11 on a side thereof remote from the variable intake cam phase mechanism 12, and delivers an intake cam signal, which is a pulse signal, to the ECU 2 along with rotation of the intake camshaft 11 whenever the intake camshaft 11 rotates through a predetermined cam angle (e.g. 1°). The ECU 2 calculates the intake cam phase CAIN based on the intake cam signal and the above-mentioned CRK signal. Note that in the present embodiment, the intake cam angle sensor 36 corresponds to intake cam phase parameter-obtaining means, and the intake cam phase CAIN corresponds to an intake cam phase parameter.

Further, the exhaust cam angle sensor 37 is disposed at an end of the exhaust camshaft 21 on a side thereof remote from the variable exhaust cam phase mechanism. 22, and delivers an exhaust cam signal, which is a pulse signal, to the ECU 2 along with rotation of the exhaust camshaft 21 whenever the exhaust camshaft 21 rotates through a predetermined cam angle (e.g. 1°). The ECU 2 calculates the exhaust cam phase CAEX based on the exhaust cam signal and the above-mentioned CRK signal.

The ECU 2 is implemented by a microcomputer comprising a CPU, a RAM, a ROM, and an I/O interface (none of which are specifically shown). Further, the ECU 2 executes a process for calculating an internal EGR amount based on the detection signals from the aforementioned sensors 30 to 37, as described hereinafter, and controls the operations of the spark plugs 6, the fuel injection valves 7, the intake cam phase control valve 12a, and the exhaust cam phase control valve 22a.

Note that in the present embodiment, the ECU 2 corresponds to in-cylinder volume-calculating means, internal EGR amount-calculating means, remaining gas amount-calculating mean, minimum exhaust pressure-obtaining means, blown-back gas amount-calculating mean, intake cam phase parameter-obtaining means and engine speed-obtaining means.

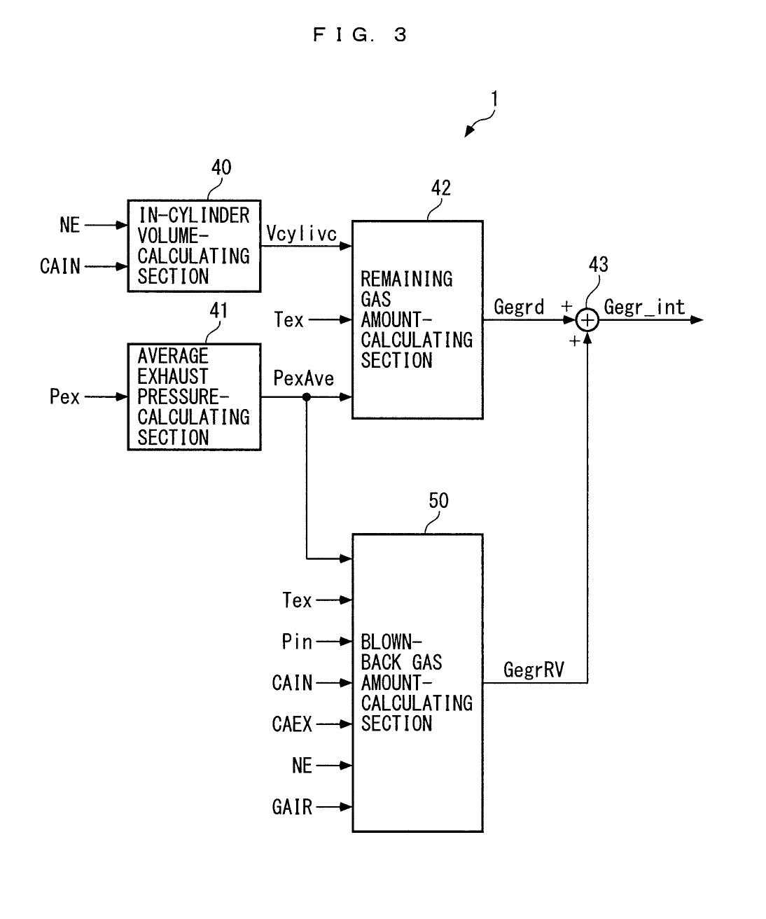

Next, the functional configuration of the internal EGR amount calculation device 1 according to the present embodiment will be described with reference to FIG. 3. As shown in FIG. 3, the internal EGR amount calculation device 1 comprises an in-cylinder volume-calculating section 40, an average exhaust pressure-calculating section 41, a remaining gas amount-calculating section 42, an adder 43, and a blown-back gas amount-calculating section 50, all of which are implemented by the ECU 2.

The in-cylinder volume-calculating section 40 (in-cylinder volume-calculating means) calculates an in-cylinder volume Vcylivc by searching a map, not shown, according to the engine speed NE and the intake cam phase CAIN. The in-cylinder volume Vcylivc represents the volume of gases in each cylinder 3a at a timing at which the blow-back of exhaust gases from the exhaust passage 9 into the cylinder 3a occurs upon opening of an associated one of the intake valves 4 during the valve overlap time period, i.e. at a blow-back occurrence timing. The reason why the in-cylinder volume Vcylivc is calculated by the above-described method will be described hereinafter.

Further, the average exhaust pressure-calculating section 41 calculates an average exhaust pressure PexAve, as described hereafter. More specifically, the average exhaust pressure PexAve is calculated by sampling the exhaust pressure Pex in synchronism with generation of the TDC signal, and performing moving average processing of sampled values of the exhaust pressure Pex per one combustion cycle.

Furthermore, the remaining gas amount-calculating section 42 (internal EGR amount-calculating means, remaining gas amount-calculating mean) calculates a remaining gas amount Gegrd by the following equation (1):

$$Gegrd = \frac{PexAve \cdot Vcylivc}{Re \cdot Tex} \qquad ( 1 )$$

This equation (1) corresponds to the equation of state of gas, wherein Re represents a gas constant. The remaining gas amount Gegrd corresponds to the amount of burned gases remaining in the cylinder 3a at the blow-back occurrence timing.

Further, the blown-back gas amount-calculating section 50 (internal EGR amount-calculating means, blown-back gas amount-calculating mean) calculates a blown-back gas amount GegrRV using various parameters, such as the average exhaust pressure PexAve and the exhaust gas temperature Tex, by a method, described hereinafter.

Then, the adder 43 (internal EGR amount-calculating means) calculates an internal EGR amount Gegr_int by the following equation (2):

Gegr_int=Gegrd+GegrRV (2)

As expressed by the above-mentioned equation (2), the internal EGR amount calculation device 1 calculates the internal EGR amount Gegr_int as the sum of the remaining gas amount Gegrd and the blown-back gas amount GegrRV.

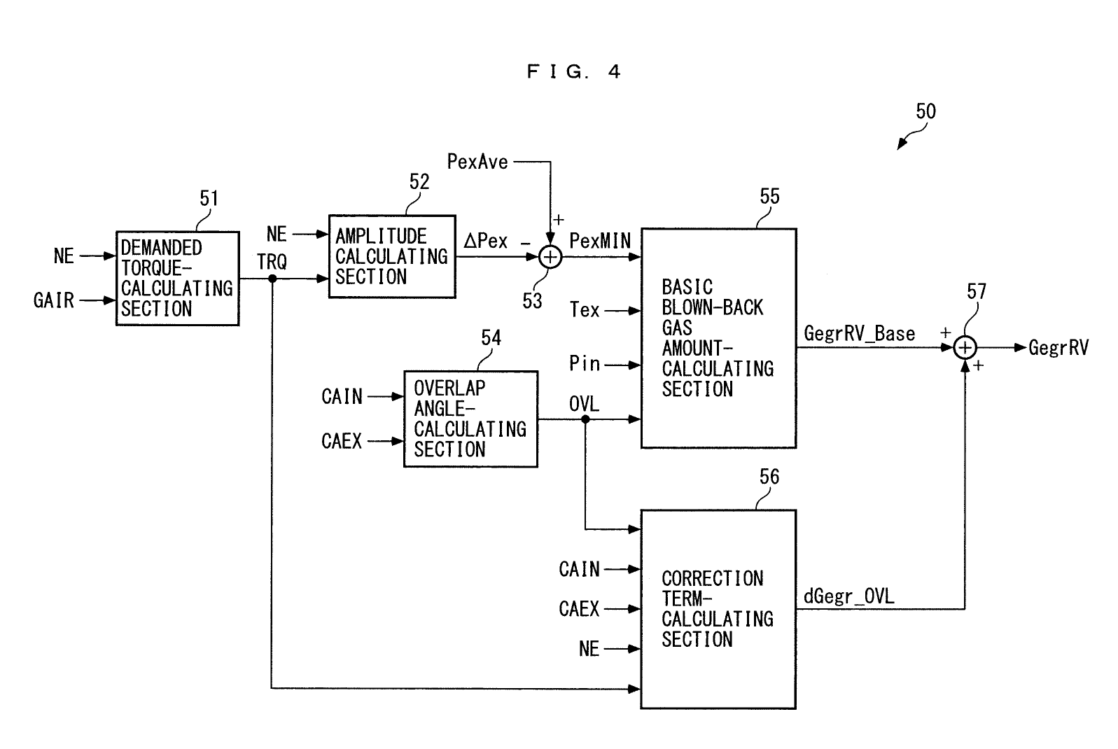

Next, the blown-back gas amount-calculating section 50 will be described with reference to FIG. 4. As shown in FIG. 4, the blown-back gas amount-calculating section 50 comprises a demanded torque-calculating section 51, an amplitude calculating section 52, a subtractor 53, an overlap angle-calculating section 54, a basic blown-back gas amount-calculating section 55, a correction term-calculating section 56, and an adder 57.

First, the demanded torque-calculating section 51 calculates a demanded torque TRQ by searching a map, not shown, according to the engine speed NE and the intake air amount GAIR.

Next, the amplitude calculating section 52 calculates an amplitude ΔPex by searching a map, not shown, according to the demanded torque TRQ and the engine speed NE.

Then, the subtractor 53 calculates a minimum exhaust pressure PexMIN (first exhaust pressure parameter) by the following equation (3). The minimum exhaust pressure PexMIN corresponds to a value obtained by estimating the minimum value of the exhaust pressure Pex during the valve overlap time period.

PexMIN=PexAve−ΔPex (3)

On the other hand, the overlap angle-calculating section 54 calculates an overlap angle OVL by the following equation (4):

OVL=CAIN+CAEX (4)

Further, the basic blown-back gas amount-calculating section 55 calculates a basic blown-back gas amount GegrRV_Base using the following equations (5) to (7). The basic blown-back gas amount GegrRV_Base corresponds to a blown-back gas amount obtained when CAIN=CAEX holds.

$$\begin{matrix}GegrRv\_Base = CdA \cdot \frac{PexMIN}{\sqrt{Re \cdot Tex}} \cdot Ψ & ( 5 ) \\ \cdot When \frac{Pin}{PexMIN} > {( \frac{2}{κ + 1} )}^{\frac{κ}{κ - 1}} \\ Ψ = \sqrt{\frac{2 κ}{κ - 1} \{ {( \frac{Pin}{PexMIN} )}^{\frac{2}{κ}} - {( \frac{Pin}{PexMIN} )}^{\frac{κ + 1}{κ}} \}} & ( 6 ) \\ \cdot When \frac{Pin}{PexMIN} ≦ {( \frac{2}{κ + 1} )}^{\frac{κ}{κ - 1}} \\ Ψ = \sqrt{{κ ( \frac{2}{κ + 1} )}^{\frac{κ + 1}{κ - 1}}} & ( 7 )\end{matrix}$$

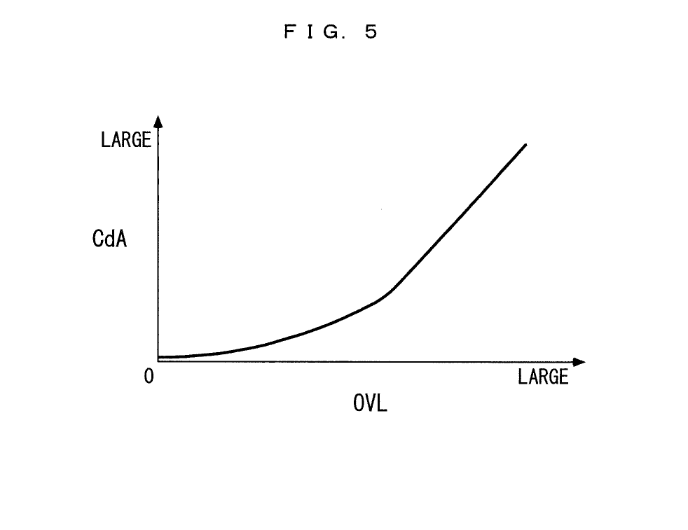

In the above-mentioned equation (5), CdA represents a function value corresponding to the product of an effective opening area and a flow rate coefficient. The function value CdA is specifically calculated by searching a map shown in FIG. 5 according to the overlap angle OVL. Further, in the equation (5), Ψ represents a flow rate function calculated by the equations (6) and (7). Further, in the equations (6) and (7), κ represents a specific heat ratio.

As expressed by the above-described equations (5) to (7), in the present embodiment, the basic blown-back gas amount GegrRV_Base is calculated using the minimum exhaust pressure PexMIN. This is because, as disclosed in Japanese Patent Application No. 2012-152089 by the present assignee, when calculating the blown-back gas amount, if the valve overlap time period is long or if the operating load of the engine 3 is high, the calculation accuracy of the blown-back gas amount is enhanced by using the minimum exhaust pressure PexMIN, which is the minimum value of the pressure within the exhaust passage 9 during the valve overlap time period.

Note that the above-described equations (5) to (7) are derived using a nozzle equation by regarding blown-back gases (i.e. burned gases) as an adiabatic flow of compressible fluid and at the same time regarding a path through which blown-back gases flow as a nozzle. A method of deriving the equations (5) to (7) is the same as one described e.g. in Japanese Laid-Open Patent Publication (Kokai) No. 2011-140895 by the present assignee, and hence description thereof is omitted.

The correction term-calculating section 56 calculates a correction term dGegr_OVL, as described hereafter. First, the correction term-calculating section 56 calculates a correction coefficient KGegr by searching a map, not shown, according to the overlap angle OVL and the demanded torque TRQ. Further, the correction term-calculating section 56 calculates an overlap center position OVL_Center based on the exhaust cam phase CAEX and the intake cam phase CAIN. The overlap center position OVL_Center corresponds to a crank angle position at a center between the start point and end point of the valve overlap time period. The correction term dGegr_OVL is calculated by multiplying the overlap center position OVL_Center by the correction coefficient KGegr.

Then, finally, the adder 50 calculates the blown-back gas amount GegrRV by the following equation (8):

GegrRY=GegrRV_Base+dGegr_OVL (8)

As described above, the blown-back gas amount GegrRV is calculated by correcting the basic blown-back gas amount GegrRV_Base using the correction term dGegr_OVL.

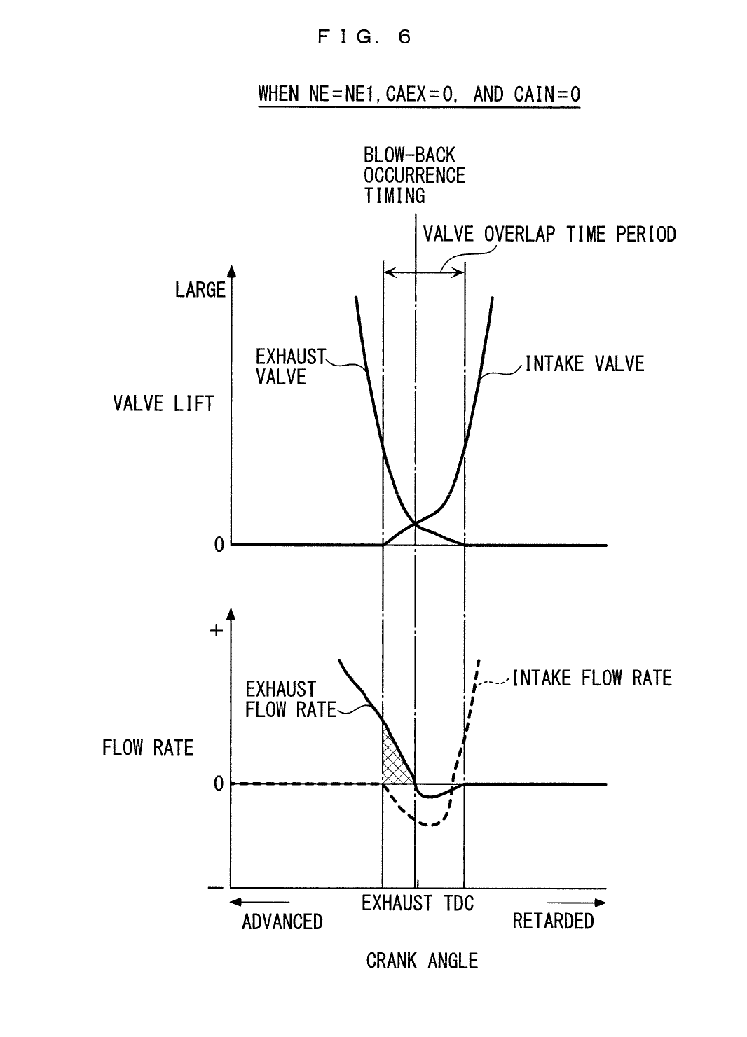

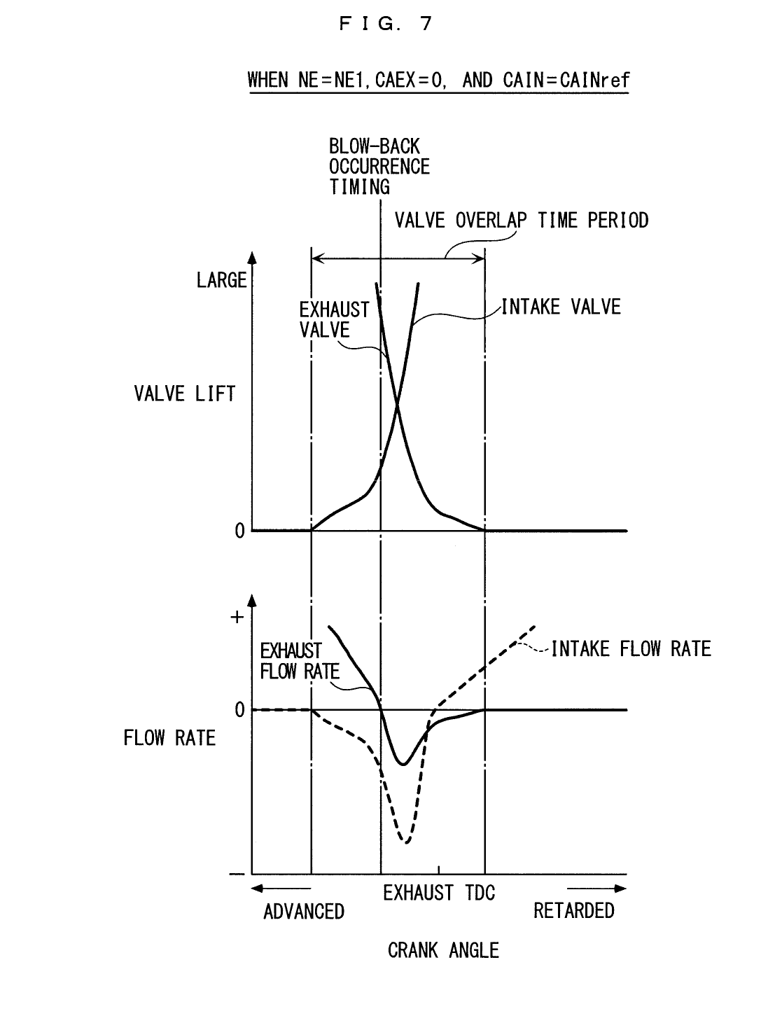

Next, a description will be given of the reason and viewpoint for calculating the in-cylinder volume Vcylivc according to the engine speed NE and the intake cam phase CAIN, as described hereinabove. First, the relationship between the intake cam phase CAIN and the in-cylinder volume Vcylivc will be described with reference to FIGS. 6 to 8. FIGS. 6 and 7 show results of measurement of an intake flow rate and an exhaust flow rate, respectively. FIG. 6 shows the results of measurement of the intake flow rate and the exhaust flow rate when the intake cam phase CAIN is set to 0 in a case where the engine speed NE is held at a predetermined value NE1 and the exhaust cam phase CAEX is held at 0.

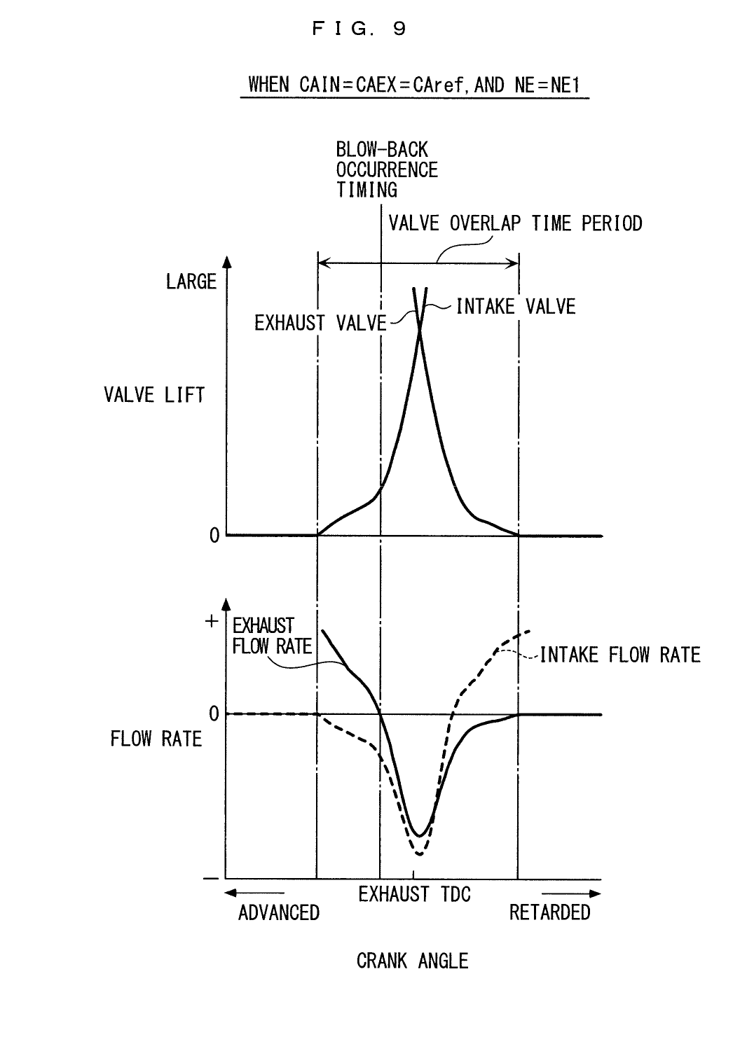

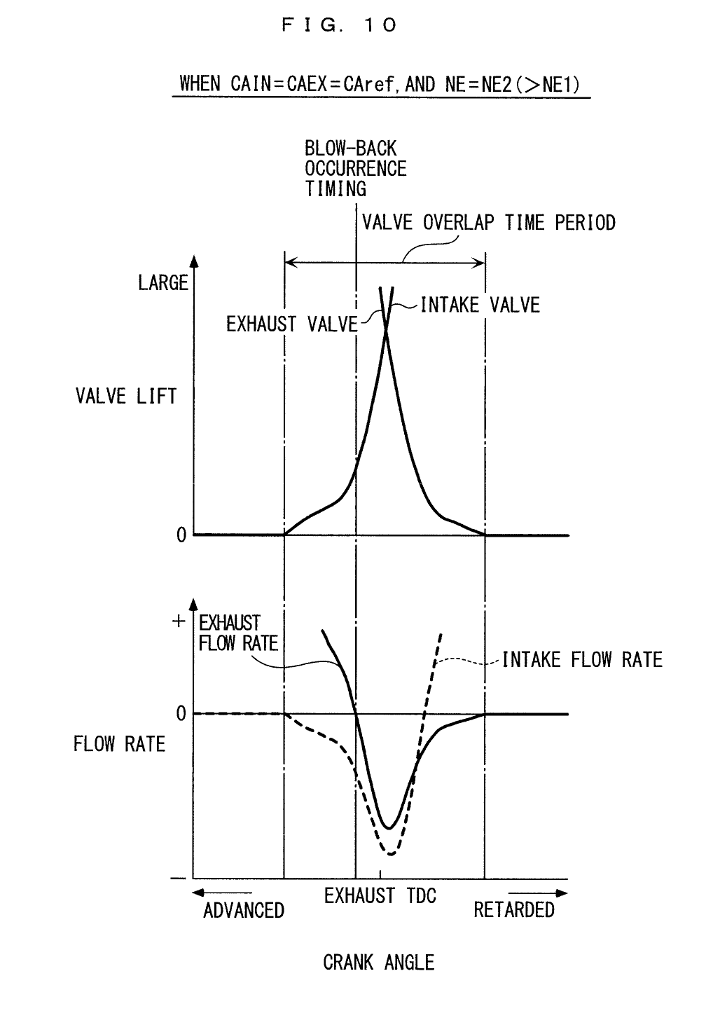

FIG. 7 shows the results of measurement of the intake flow rate and the exhaust flow rate when the intake cam phase CAIN is set to a predetermined value CAIN_ref in a case where the engine speed NE and the exhaust cam phase CAEX are held at the same values as shown in FIG. 6, respectively. The predetermined value CAIN_ref represents a value which satisfies 0<CAIN_ref<CAEX_rt. Further, in the case of FIGS. 6 and 7, the values of the intake flow rate and the exhaust flow rate are represented by positive values when blown-back gases flow from the intake passage to the exhaust passage, but inversely, when blown-back gases flow from the exhaust passage to the intake passage, they are represented by negative values. This also applies to FIGS. 9 and 10, referred to hereinafter.

First, in the result of the measurement in FIG. 6, the intake valve 4 starts to open at a time when the crank angle has reached a more advanced position than the exhaust top dead center by a predetermined value. At this time, the lift of the exhaust valve 5 is larger than that of the intake valve 4, and the piston 3b is rising, and hence burned gases in the piston 3a flow out of the cylinder 3a into the exhaust passage 9, whereby the exhaust flow rate has a positive value. In this case, a cross-hatched area in FIG. 6 corresponds to a region in which outflow of burned gases into the exhaust passage 9 occurs. When the piston 3b passes the exhaust top dead center along with rotation of the crankshaft 3c, the lift of the exhaust valve 5 becomes approximately equal to the lift of the intake valve 4 in a slightly more advanced timing than the exhaust top dead center, and the exhaust flow rate temporarily becomes equal to 0, whereafter the blow-back of exhaust gases from the exhaust passage occurs, whereby the exhaust flow rate comes to assume a negative value. That is, the slightly more advanced timing than the exhaust top dead center becomes the blow-back occurrence timing.

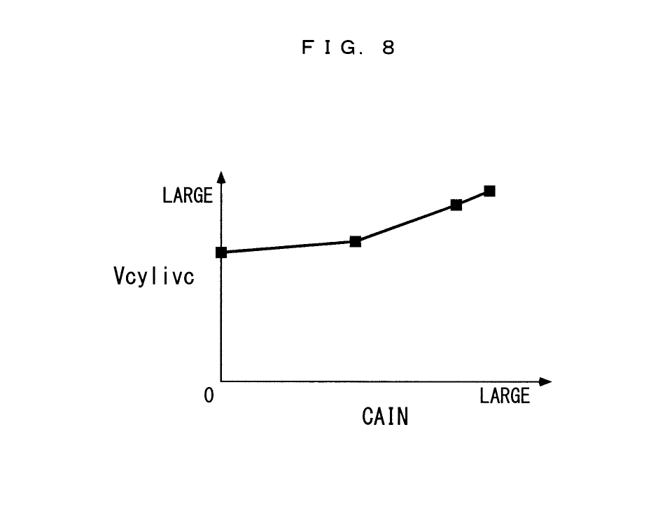

In the results of the measurement in FIG. 7, the blow-back occurrence timing is more advanced, compared with the results of measurement in FIG. 6. More specifically, as the intake cam phase CAIN is increased, causing the valve-opening timing of the intake valve 4 to be advanced, the blow-back occurrence timing is more advanced. In addition to this, it is understood that the lift of the intake valve 4 at the blow-back occurrence timing is larger in FIG. 7 than in FIG. 6. Due to such a change in the blow-back occurrence timing and a change in the lift of the intake valve 4 at the blow-back occurrence timing, as caused by the change in the intake cam phase CAIN, described above, the relationship between the intake cam phase CAIN and the in-cylinder volume Vcylivc becomes as shown in FIG. 8.

Next, the relationship between the engine speed NE and the in-cylinder volume Vcylivc will be described with reference to FIGS. 9 to 11. FIG. 9 shows results of measurement of the intake flow rate and the exhaust flow rate when the engine speed NE is set to the predetermined value NE1 in a case where both the intake cam phase CAIN and the exhaust cam phase CAEX are held at a predetermined value CA_ref. FIG. 10 shows results of measurement of the intake flow rate and the exhaust flow rate when the engine speed NE is set to a predetermined value NE2 larger than the predetermined value NE1 in a case where both the intake cam phase CAIN and the exhaust cam phase CAEX are held at the same value as shown in FIG. 9.

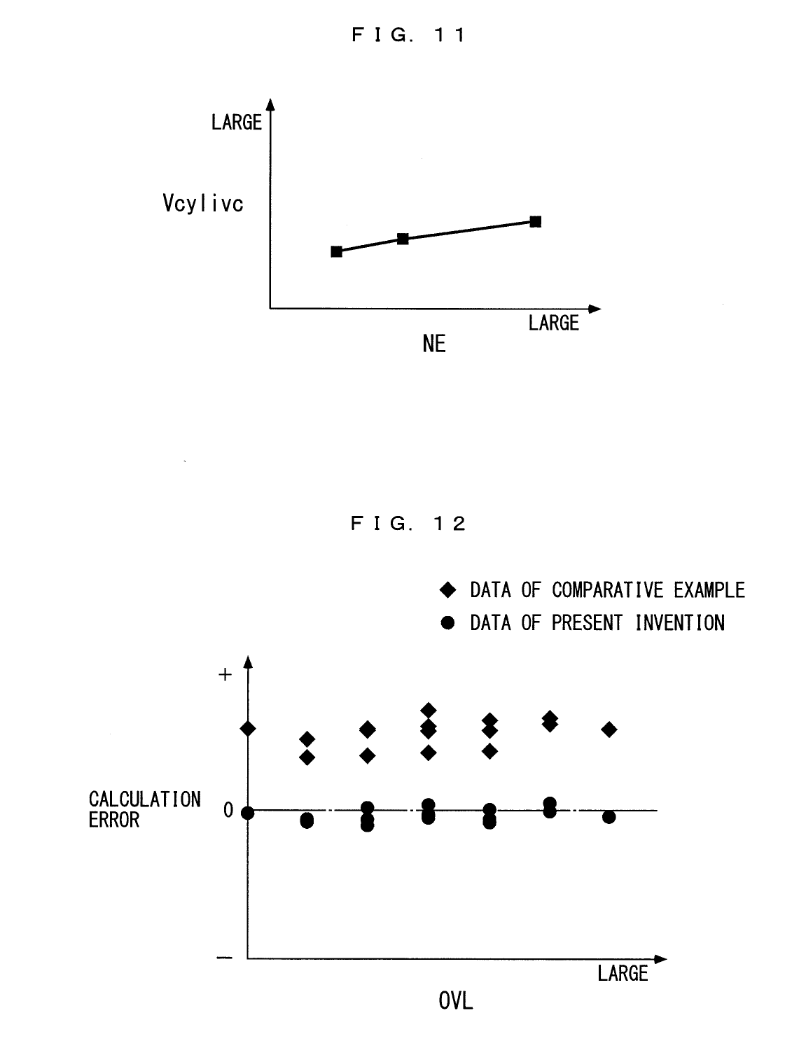

As is clear from a comparison between FIGS. 9 and 10, it is understood that the blow-back occurrence timing is more retarded in the results of measurement in FIG. 10 than in the results of measurement in FIG. 9, and the lift of the intake valve 4 at the blow-back occurrence timing is larger in FIG. 10 than in FIG. 9. Due to such a change in the blow-back occurrence timing and a change in the lift of the intake valve 4 at the blow-back occurrence timing, as caused by the change in the engine speed NE, described above, the relationship between the engine speed NE and the in-cylinder volume Vcylivc becomes as shown in FIG. 11.

As described above, the in-cylinder volume Vcylivc at the blow-back occurrence timing is highly correlated with the engine speed NE and the intake cam phase CAIN, and varies with the changes in these parameters. Therefore, to accurately calculate the in-cylinder volume Vcylivc, in the present embodiment, the in-cylinder volume Vcylivc is calculated by searching a map set based on the engine speed NE and the intake cam phase CAIN, as mentioned hereinabove.

Next, the accuracy of the calculation result of the internal EGR amount Gegr_int by the internal EGR amount calculation device 1 according to the present embodiment will be explained with reference to FIG. 12. In FIG. 12, data indicated by solid circles represents the relationship between calculation errors in the internal EGR amount Gegr_int calculated by the internal EGR amount calculation device 1 according to the present embodiment (hereinafter referred to as the “calculation error in the present invention”) and the overlap angle OVL, and a calculation error indicated by each solid circle corresponds to a value obtained by subtracting a measured value from a calculated value Gegr_int of the internal EGR amount. Further, data indicated by solid squares represents, for comparison, indicates calculation errors in the internal EGR amount in a comparative example obtained by subtracting a measured value from a result of calculation of the internal EGR amount in which the in-cylinder volume used for calculation of the remaining gas amount Gegrd is set to a value to be assumed at the valve-opening timing of the intake valve 4.

As shown in FIG. 12, although the calculation error in the present invention is held close to 0, the calculation error in the comparative example has a value more positive than the calculation error in the present invention, and it is understood that the calculation accuracy of the internal EGR amount Gegr_int is improved by the method of calculating the internal EGR amount according to the present embodiment. This is because in the case of the method employed in the comparative example, as described hereinabove, the amount of burned gases flowing out into the exhaust passage 9 before occurrence of the blow-back of exhaust gases is included in the calculation result of the internal EGR amount, and hence the calculation result of the internal EGR amount has a larger value than an actual value.

As described heretofore, according to the internal EGR amount calculation device 1 of the present embodiment, the in-cylinder volume Vcylivc is calculated according to the engine speed NE and the intake cam phase CAIN; the remaining gas amount Gegrd is calculated according to the in-cylinder volume Vcylivc; the blown-back gas amount GegrRV is calculated according to the minimum exhaust pressure PexMIN; and the internal EGR amount Gegr_int is calculated by adding the blown-back gas amount GegrRV to the in-cylinder volume Vcylivc.

In this case, as described hereinabove, the in-cylinder volume Vcylivc is highly correlated with the intake cam phase CAIN and the engine speed NE, so that by calculating the in-cylinder volume Vcylivc according to the intake cam phase CAIN and the engine speed NE, it is possible to accurately calculate the in-cylinder volume Vcylivc.

Further, during the valve overlap time period, the in-cylinder volume Vcylivc is calculated as a value obtained at a timing at which the blow-back of exhaust gases from the exhaust passage 9 into the cylinder 3a occurs upon opening of the intake valve 4, i.e. at the blow-back occurrence timing, and hence differently from the method disclosed in Japanese Laid-Open Patent Publication (Kokai) No. 2004-251182, it is possible to calculate the remaining gas amount Gegrd as a value exclusive of the amount of burned gases that flow out into the exhaust passage 9 before occurrence of the blow-back of exhaust gases after the intake valve 4 is opened. This makes it possible to improve the calculation accuracy of the internal EGR amount Gegr_int.

Furthermore, the present assignee has confirmed by experiment that in the engine 3 capable of changing the valve overlap time period, when the blown-back gas amount GegrRV is calculated, if the valve overlap time period is long or if the operating load of the engine 3 is high, the calculation accuracy of the blown-back gas amount GegrRV is improved by using the minimum value of the pressure within the exhaust passage 9 during the valve overlap time period. Therefore, it is possible to improve the calculation accuracy of the blown-back gas amount GegrRV by the above-described calculation method. Further, the internal EGR amount Gegr_int is calculated by adding the blown-back gas amount GegrRV accurately calculated as described above to the remaining gas amount Gegrd, and therefore it is possible to accurately calculate the internal EGR amount even when the valve overlap time period is long or even when the operating load of the engine 3 is high, thereby making it possible to further improve the calculation accuracy of the internal EGR amount.

Although in the above-described embodiment, the engine 3 including the variable intake cam phase mechanism 12 and the variable exhaust cam phase mechanism 22 is used as an internal combustion engine capable of changing the valve timing of at least one of each intake valve 4 and each exhaust valves 5, by way of example, the engine to which the present invention is applied is not limited to this, but any suitable engine may be employed insofar as it can change the valve timing of at least one of each intake valve and each exhaust valve. For example, as the engine, there may be employed an internal combustion engine including one of the variable intake cam phase mechanism 12 and the variable exhaust cam phase mechanism 22 or an internal combustion engine which changes the valve timing of at least one of each intake valve 4 and each exhaust valve 5 using a mechanism other than the variable intake cam phase mechanism 12 and the variable exhaust cam phase mechanism 22. For example, as a mechanism for changing the cam phase, there may be employed a variable cam phase mechanism formed by combining an electric motor and a gear mechanism, an electromagnetic valve-actuating mechanism which has a valve element actuated by a solenoid, or a valve timing changing mechanism for mechanically changing the valve timing using a three-dimensional cam.

Further, although in the above-described embodiment, the intake cam phase CAIN is used as the intake cam phase parameter, by way of example, the intake cam phase parameter in the present invention is not limited to this, but any suitable intake cam phase parameter may be used insofar as it represents the intake cam phase. For example, as the intake cam phase parameter, a value of a control input signal to the variable intake cam phase mechanism 12 may be used. In this case, it is only required to calculate the in-cylinder volume Vcylivc according to the value of the control input signal.

Furthermore, although in the above-described embodiment, the in-cylinder volume Vcylivc is calculated according to the intake cam phase CAIN and the engine speed NE, by way of example, the in-cylinder volume Vcylivc may be calculated according to one of the intake cam phase CAIN and the engine speed NE.

On the other hand, although in the above-described embodiment, the internal EGR amount calculation device 1 according to the present invention is applied to the engine 3 installed on a vehicle, by way of example, this is not limitative, but it can be applied to an internal combustion engine installed on boats or other industrial machines.

It is further understood by those skilled in the art that the foregoing are preferred embodiments of the invention, and that various changes and modifications may be made without departing from the spirit and scope thereof.

What is claimed is:

1. An internal EGR amount calculation device for an internal combustion engine in which a valve overlap time period is changed by changing valve timing of at least one of an intake valve and an exhaust valve, and an internal EGR amount, which is an amount of gases remaining in a cylinder, is changed according to the change in the valve overlap time period, comprising:
in-cylinder volume-calculating means for calculating an in-cylinder volume at a blow-back occurrence timing, which is a timing at which blow-back of exhaust gases from an exhaust passage into the cylinder occurs after the intake valve is opened, during the valve overlap time period; and
internal EGR amount-calculating means for calculating the internal EGR amount according to the calculated in-cylinder volume.

2. The internal EGR amount calculation device according to claim 1, wherein said internal EGR amount-calculating means includes remaining gas amount-calculating mean for calculating a remaining gas amount of gases remaining in the cylinder according to the in-cylinder volume, and calculates the internal EGR amount using the calculated remaining gas amount.

3. The internal EGR amount calculation device according to claim 2, further comprising minimum exhaust pressure-obtaining means for obtaining a minimum exhaust pressure, which is a minimum value of pressure within the exhaust passage during the valve overlap time period,
wherein said internal EGR amount-calculating means further includes blown-back gas amount-calculating mean for calculating a blown-back gas amount, which is an amount of gases which temporarily flow out of the cylinder into at least one of an intake passage and the exhaust passage, and then flow back into the cylinder again, according to the obtained minimum exhaust pressure, and calculates the internal EGR amount further using the calculated blown-back gas amount in addition to the remaining gas amount.

4. The internal EGR amount calculation device according to claim 1, wherein the engine includes a variable intake cam phase mechanism for changing an intake cam phase, which is a phase of an intake camshaft for opening and closing the intake valve, with respect to a crankshaft,
the internal EGR amount calculation device further comprising intake cam phase parameter-obtaining means for obtaining an intake cam phase parameter indicative of the intake cam phase, and
wherein said in-cylinder volume-calculating means calculates the in-cylinder volume according to the obtained intake cam phase parameter.

5. The internal EGR amount calculation device according to claim 2, wherein the engine includes a variable intake cam phase mechanism for changing an intake cam phase, which is a phase of an intake camshaft for opening and closing the intake valve, with respect to a crankshaft,
the internal EGR amount calculation device further comprising intake cam phase parameter-obtaining means for obtaining an intake cam phase parameter indicative of the intake cam phase, and
wherein said in-cylinder volume-calculating means calculates the in-cylinder volume according to the obtained intake cam phase parameter.

6. The internal EGR amount calculation device according to claim 3, wherein the engine includes a variable intake cam phase mechanism for changing an intake cam phase, which is a phase of an intake camshaft for opening and closing the intake valve, with respect to a crankshaft,
the internal EGR amount calculation device further comprising intake cam phase parameter-obtaining means for obtaining an intake cam phase parameter indicative of the intake cam phase, and
wherein said in-cylinder volume-calculating means calculates the in-cylinder volume according to the obtained intake cam phase parameter.

7. The internal EGR amount calculation device according to claim 1, further comprising engine speed-obtaining means for obtaining an engine speed, which is a rotational speed of the engine, and
wherein said in-cylinder volume-calculating means calculates the in-cylinder volume according to the obtained engine speed.

8. The internal EGR amount calculation device according to claim 2, further comprising engine speed-obtaining means for obtaining an engine speed, which is a rotational speed of the engine, and
wherein said in-cylinder volume-calculating means calculates the in-cylinder volume according to the obtained engine speed.

9. The internal EGR amount calculation device according to claim 3, further comprising engine speed-obtaining means for obtaining an engine speed, which is a rotational speed of the engine, and
wherein said in-cylinder volume-calculating means calculates the in-cylinder volume according to the obtained engine speed.
